(19) United States
(12) Patent Application Publication
(10) Pub. No.: US 2008/0305449 A1
(43) Pub. Date: Dec. 11, 2008

(54) Method of preparing a surface for attaching of an orthodontic device

(75) Inventor: Goran Steen, Hovas (SE)

Correspondence Address: YOUNG & THOMPSON, 209 Madison Street, Suite 500, ALEXANDRIA, VA, 22314, US

(73) Assignee: GESTENCO INTERNATIONAL AB, Goteborg (SE)

(21) Appl. No.: 11/808,048

(22) Filed: Jun. 6, 2007

(51) Int. Cl. A61C 7/00

(52) U.S. Cl. 433/2

(57) ABSTRACT

A method of preparing a surface of a tooth for attachment of an orthodontic device on a lingual surface of a tooth includes the step that a material mass is applied on the tooth to fill out one or more irregularities on the inside of the tooth. Thereafter the material mass is allowed to become hard and is shaped to achieve a preferably flat attachment surface for an orthodontic bracket or similar device.

### TECHNICAL FIELD

The present invention relates to a method of preparing a surface for attaching of an orthodontic device on a lingual surface of a tooth and comprises the steps that a material mass is applied on the tooth to fill out an irregularity on the inside of the tooth, that the material is allowed to become hard and that the material mass is shaped to achieve an attachment surface for the orthodontic brackets or similar devices.

### BACKGROUND ART

Positioning of dental or orthodontic brackets or similar devices on the teeth of a patient for correcting the location and position or other treatment of the teeth is well known in the technical field. In the known art the brackets comprised a band to be placed around the teeth whereby each band was equipped with a protuberance to which wires and bands could be attached in order to link the system. Nowadays, brackets are commonly attached by cementing the base of the bracket where needed to the surface of the teeth and thereby eliminating the need for bands encircling the teeth.

One common way of positioning the brackets is to first make a replica of the patient's teeth for pre-positioning of the brackets, followed by the transfer of the brackets from the model to the patient's teeth. According to a well known method, the transfer may be made by the use of a single moulded cast to move all brackets as a unit from the dental cast to the patient's teeth. In this technique, the brackets are first put on the dental cast which is a replica of the patient's teeth. The next step is to make a positioner or “tray” by moulding around the brackets and the dental cast. The positioner is allowed to set and when it is removed, the brackets are removed with the positioner. This mould may thereafter be positioned on the patient's teeth whereby the brackets are cemented on the teeth. An example of such a method is disclosed in U.S. Pat. No. 4,501,554. This method usually works well but has the disadvantage of being complicated. In many cases a dentist or an orthodontic clinic do not have the resources for making these models or being able to perform the transfer of the brackets to the positioner and the setup therefore has to be sent away to a specialist. This procedure is generally time-consuming and thus expensive since the process requires the involvement of several persons or institutes. Even if there are in-house resources for making the positioner, there is still the need for another step, i.e. the making of the positioner, to be processed when using this method.

According to another method, the brackets are removed from the model one by one and positioned one at a time on the patient's teeth. According to this method, there is no need for making the moulded positioner and the process can be performed more easily. However, there is a difficulty in placing the brackets on the desired positions on the surface of the teeth. In particular, this is a problem when a lingual bracket is to be placed since it is more difficult to get a sufficient visual perception of how the bracket is placed while the positioning procedure is going on.

In WO 2006/107652 a method of making transfer apparatus for use in indirect bonding of orthodontic appliances is disclosed. The method comprises the steps of providing a replica of the patient's dentition whereafter a spacer material is applied over the replica of the patient's dentition. The spacer material has at least one cavity for placing of an orthodontic appliance. The next step is to place an orthodontic appliance in the cavity of the spacer material such that a base of the appliance is in contact with a tooth of the replica dentition and temporarily fixing the base of the appliance to the tooth of the replica. A tray is then formed over the spacer material, whereafter the tray is removed from the spacer material, and the spacer material is detached from the replica. A quantity of matrix material is directed onto at least one of the tray and the replica, and the tray is placed over the replica such that the matrix material is between the tray and the replica, in order to releasably hold the appliance for an indirect bonding procedure. As a last act the transfer apparatus is moved into a patient's oral cavity in order to locate the orthodontic appliance adjacent to one of the patient's teeth. This method usually works well but has the disadvantage of being complicated and costly. In many cases a dentist or an orthodontic clinic does not have the resources for making these transfer apparatuses and the setup therefore has to be sent away to a specialist. This procedure is generally time-consuming and the process requires the involvement of several persons or institutes.

Hence, there is a need for an improved method for attaching an orthodontic device on the lingual side of a tooth which can replace the rather time consuming and costly procedures which are used today and allow the person skilled in the art to easily attach the orthodontic device on a tooth.

### SUMMARY OF THE INVENTION

The object of the present invention is to design a method that reduces the steps involved in the process of creating attachment surfaces on lingual surfaces of teeth. A further object of the invention is to simplify the attachment of the orthodontic devices on the lingual surfaces of the teeth and to achieve an even tension between the teeth with a wire provided in the brackets.

In the description the expression “orthodontic device” denotes brackets, tubes, bite ramps or similar devices, which are intended to be attached to the teeth for orthodontic treatment and correction of irregularities of teeth. Where general directions or locations such as up and down etc. are used in the description, they are to be interpreted as up and down in the patient's oral cavity.

According to the invention, the method relates to a method for preparing a surface for attaching of brackets and similar orthodontic devices, on a lingual surface of a tooth.

Several steps have to be carried out before an orthodontic device, for example a brace, can be attached to a patient's teeth. In the case where orthodontic devices are going to be attached to the buccal surfaces of the teeth, the surfaces of the teeth do not need to be considerably reshaped since they are in general quite smooth and convex and the orthodontic devices are easy to attach directly on the buccal surfaces. Furthermore, the buccal surfaces can easily be seen by the dentist, when the patient has his or her mouth open. This enables easy positioning of the orthodontic devices before the orthodontic devices are attached on the teeth.

In the case where the orthodontic devices are going to be attached to lingual surfaces of the teeth, the attachment procedure is more complicated.

According to the present invention, the method comprises the following steps:
Applying a material mass onto a tooth to fill out at least one irregularity on the lingual surface of the tooth,
Allowing the material mass to become hard
Shaping the material mass to achieve an attachment surface for orthodontic brackets and the like devices.

It shall be noted that the shaping of the material mass to provide a surface suitable for attaching the orthodontic device to the tooth may either be performed after the material mass is allowed to harden or cure, i.e. in the order as described above, or it may be shaped to achieve the desired form and surface properties during appliance of the mass to the tooth and then allowed to harden or cure. The method may of course also include a combination of these two form shaping steps, e.g. applying the material essentially so that it corresponds to the desired form and shape and afterwards performing some finishing treatment in order to induce the desired surface properties on the hardened attachment material.

According to one embodiment of the invention, the method further comprises attachment of an orthodontic device on the attachment surface. The attachment surface should at the step of appliance of the orthodontic device be well prepared for the appliance, e.g. the overall structure of the surface should have a desired shape, e.g. planar or adapted in other ways to fit the surface of the attachment surface of the orthodontic device, and surface finish, e.g. rugged or smooth depending on the material and surface properties of the orthodontic device and the glue or cement used to fasten the orthodontic device to the prepared surface. The glue to be used shall of course be adapted to be resistant to the wet environment and be strong enough to withstand the forces which might work on the attached orthodontic device when it is used for its intended purpose, e.g. bracket for holding a wire and being used so as to correct the position of a tooth.

One embodiment of the invention which may be advantageously used is that the applied material mass applied to the lingual surface of the tooth may be shaped to transform the generally concave surface of the tooth to a generally planar surface. In general it is an advantageous feature to have a planar surface for attachment of the orthodontic device, which attachment surface usually is planar, since it provides for the possibility to place the orthodontic device at a desired location on the planar surface and need not to be fitted at a specific location in order to be fastened in a satisfactorily way. The planar surface made may be possible to shape such that it has a certain inclination or gradient with respect to the tooth itself or to the surfaces of the neighbouring teeth, which also may have been shaped by using this method, such that several orthodontic devices attached to different teeth, e.g. brackets to be connected by a wire, may easily be located such that they may cooperate with each other in an optimised way. However, it is also possible that the surface may be shaped in any other desired way, e.g. to fit a certain shape of the surface with a complimentary shape of the attachment surface of the orthodontic device, such that the orthodontic device is fitted to a certain position or to some different possible positions.

As already described above the material mass may be shaped to the desired form and surface structure through grinding or polishing or by other means for shaping the hardened surface.

The material mass applied to the lingual surface of the tooth may be a composite based on a polymer or a flowable composite such an unpolymerized resin or other appropriate materials for shaping of the lingual attachment surface of the tooth, whereupon orthodontic brackets and/or tubes or similar devices are attached.

### BRIEF DESCRIPTION OF THE DRAWINGS

The present invention will now be described in greater detail below, with reference to the accompanying drawings. In the accompanying drawings:

FIG. 1 shows application of a material mass onto a lingual surface of a tooth,

FIG. 2 shows measuring of the thickness of the tooth,

FIG. 3 shows shaping of the material mass,

FIG. 4 shows the orthodontic device aligned with the longitudinal axle of the tooth, and

FIG. 5 shows the orthodontic devices attached on the lingual surfaces of the teeth.

### DETAILED DESCRIPTION OF THE INVENTION

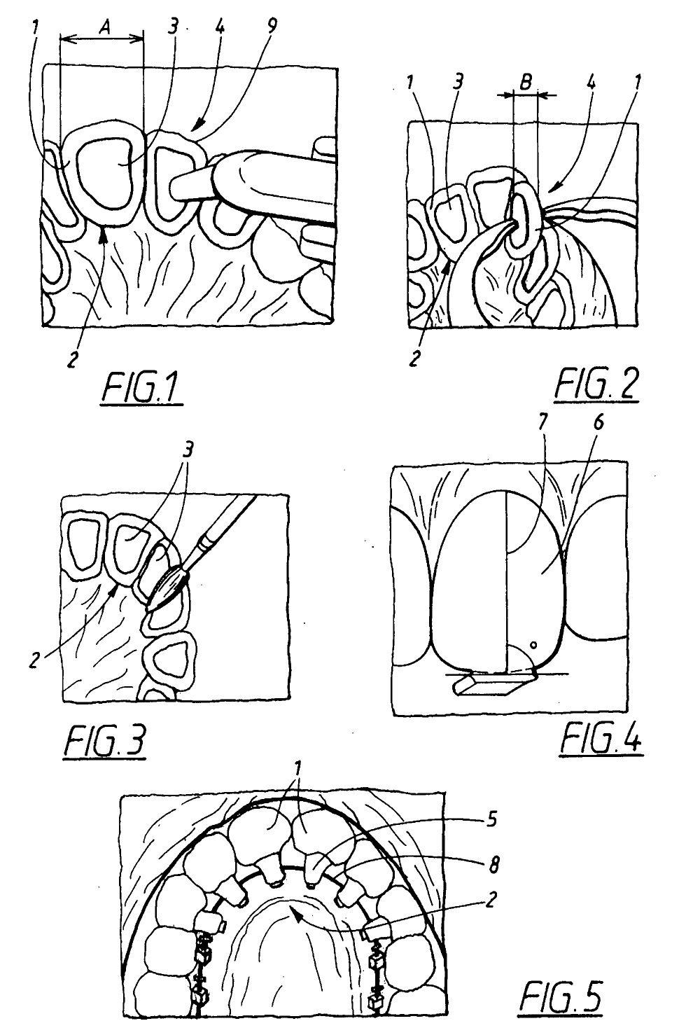

An outline of the different steps involved in the method according to the present invention is shown in FIGS. 1 to 5.

The lingual surfaces 2 of the teeth need to be considerably reshaped, especially the incisors 4, since they are more or less concave and generally full of irregularities. Because of this, the orthodontic devices 5 are not easy to attach directly on the lingual surfaces 2. Furthermore, the lingual surfaces cannot easily be seen by the dentist and this does not enable easy pre-positioning of the orthodontic device before the orthodontic device is attached.

A step according to the method is to reshape the lingual surfaces 2 on the patient's teeth 1. A material mass 3 is applied on the teeth, to fill out at least one irregularity on the inside of the teeth 1, shown in FIG. 1. The material mass 3 is a composite based on a polymer. Another example of a material mass can be a flowable composite such an unpolymerized resin. Depending on the type of composite that is applied, a suitable pre-treatment and attachment method for that type of composite is used to enable the composite to be fixed on the surfaces of the teeth.

The material mass 3 is applied on the lingual surfaces 2 to adjust for differences in thickness of the teeth 1, whereafter the material mass 3 is allowed to become hard. The material mass 3 is applied in such a way that the thickness of the teeth 3 will taper off towards the peaks 9 of the teeth, so that the thickness of the teeth will be almost the same all over the widths A of the teeth 1. To ensure that the thicknesses B of the teeth 1 are in a desired range e.g. have even thickness in the same horizontal level, they are preferably measured, as shown in FIG. 2.

There may be a desire to form the material mass 3 on the lingual surfaces 2 in such a way that the inclinations of the material mass 3 on adjacent lingual surfaces 2 are equal or approximately equal with one another in order to achieve a greater torque and a more even tension between the teeth and the orthodontic devices when they are attached on the lingual surfaces and joined with a wire 8. The greater the inclination of the surface on the lingual surfaces 2 the greater torque it is possible to achieve on the teeth 1 with the orthodontic devices 5. The material mass applied to the lingual surface of the tooth is shaped to transform the generally concave surface of the tooth to a generally planar surface.

The surfaces of the hardened material mass 3 are shaped to achieve attachment surfaces for the orthodontic brackets 5 and similar devices. The surfaces of the material mass 3 are preferably shaped through grinding to achieve substantially flat attachment surfaces, as shown in FIG. 3. The attachments surfaces can be trimmed and polished to achieve even smoother attachment surfaces.

Before the brackets 5 can be attached to the lingual surfaces of the teeth, the brackets have to be properly inclined and aligned in relation to the longitudinal axes 7 of the teeth 1. The longitudinal axes 7 are indicated on the central portion of the buccal surfaces 6, shown in FIG. 4. The brackets 5 that are to be placed on the lingual surfaces 2 of the teeth 1 are aligned with the indicated axes 7 on the buccal surfaces.

The orthodontic brackets and/or tubes and similar devices 5 are attached on the substantially flat attachment surfaces achieved with the method according to the present invention.

The brackets 5 or similar devices are attached on the lingual surfaces 2 with an adhesive, whereafter for example a wire 8 is provided in the brackets 5 to form a connection between adjacent teeth.

Alternatively, the brackets can be attached on the lingual surfaces 2 of the teeth 1 with the same material mass 3, as the inclined lingual surfaces of the teeth are constructed from.

The brackets are preferably openable. To attach the wire 8 in the brackets, the brackets have to be opened. When the brackets 5 are opened the wire 8 is placed inside the open brackets, whereafter the brackets are closed to fix the wire. The attached brackets 5 and the wire 8 are shown in FIG. 5.

According to another embodiment, the material mass 3 is a paste that is applied on the lingual surface 2 of the teeth 1 with a tool such as a depressor. The material mass 3 is levelled with the tool, to achieve substantially flat attachment surfaces. To achieve a hard material mass, the material mass is cured. Furthermore, the material mass can be trimmed and polished to achieve even flatter attachment surfaces.

The invention is not to be limited to the embodiments which are described above, but may be varied within the scope of the appended claims.

1. A method of preparing a surface for attaching of an orthodontic device on a lingual surface of a tooth comprising the steps of:
applying a material mass onto a tooth to fill out at least one irregularity on the lingual surface of the tooth,
allowing the material mass to become hard
shaping the material mass to achieve an attachment surface for brackets and similar devices.

2. The method according to claim 1, wherein said method further comprises attachment of the orthodontic device on the attachment surface.

3. The method according to claim 1, wherein the applied material mass is applied to the lingual surface of the tooth and shaped to transform the generally concave surface of the tooth to a generally planar surface.

4. The method as claimed in claim 1, wherein the material mass is shaped through grinding.

5. The method as claimed in claim 1, wherein the material mass is a composite based on a polymer.

6. The method according to claim 1, wherein orthodontic brackets and/or tubes or similar devices are attached on the attachment surface.

7. The method according to claim 2, wherein orthodontic brackets and/or tubes or similar devices are attached on the attachment surface.

8. The method according to claim 3,wherein orthodontic brackets and/or tubes or similar devices are attached on the attachment surface.
